(19) United States
(12) Patent Application Publication
(10) Pub. No.: US 2025/0017423 A1
(43) Pub. Date: Jan. 16, 2025

(54) COCKTAIL MAKING ASSEMBLY

(71) Applicant: NTSCC Ltd., Mullingar (IE)

(72) Inventors: Gerard Keena, Mullingar (IE); Trevor Murphy, Mullingar (IE)

(21) Appl. No.: 18/758,741

(22) Filed: Jun. 28, 2024

(30) Foreign Application Priority Data
Jul. 10, 2023 (GB) 2310583.6

(51) Int. Cl. A47J 43/042; B25J 11/00

(52) U.S. Cl. CPC A47J 43/042; B25J 11/008

(57) ABSTRACT

A cocktail making assembly comprising a cocktail shaker with a tumbler configured to receive a strainer comprising a strainer body defining an exterior surface sized and shaped to fit a mouth of the tumbler and an interior surface defining a channel for fluid communication with the tumbler. The channel comprising a first portion comprising a filter configured to allow passage of liquid and retention of solid material when the tumbler is tilted in a first direction; and a second portion being configured to allow passage of liquid and solid material when the tumbler is tilted in a second direction. The assembly comprising a robotic arm securely connected to and configured to move the cocktail shaker, and a controller configured to control the movement of the robotic arm to tilt the tumbler in the first direction to dispense a mixed cocktail into glassware and to retain ice within the tumbler; and to tilt the tumbler in the second direction to dispense another mixed cocktail and ice from the tumbler into glassware.

This application claims priority to UK Patent Application No. GB 2310583.6, filed Jul. 10, 2023, the disclosure of which is incorporated herein by reference in its entirety.

### FIELD

The present invention relates to a cocktail making assembly.

### BACKGROUND

Robotic cocktail makers are known, with one such example, known as Makrshakr, being produced by MIT Senseable City Lab and allowing users to request a cocktail through a user interface device, with the requested cocktail then being mixed by one of three robotic arms, whose movements mimic the actions of a bartender, for example, shaking a martini or slicing a garnish.

Robotic cocktail makers provide a consistent taste for each cocktail, as well as being able to provide a wide and increasing range of cocktail drinks, only limited by the ingredients available to the robot.

Robotic cocktail makers also allow for precise stock management and, with appropriate network connectivity, allow a central system to manage many robotic cocktail makers possibly at remote locations.

A particular consideration with such cocktail makers is that once the main ingredients for a drink have been mixed by the robot, they may need to be dispensed either with any ice present in the shaker or without dispensing such ice into a serving glass.

Makrshakr comprises a shaker comprising a strainer which is moveable either to cover an opening of the shaker prior to dispensing a mixed cocktail without its ice or away from the opening in order to dispense a mixed cocktail with its ice.

However, this moveable part requires additional control circuitry and increases the maintenance requirement and the possibility of downtime for the cocktail maker.

It is an object of the present invention to provide a cocktail making assembly which mitigates the above such problems.

### SUMMARY

According to the present invention, there is provided a cocktail making assembly according to claim 1.

Particular embodiments of the system provide a strainer configured to fit into the mouth of a mixed drink containing vessel. The interior surface of the strainer defines a channel for fluid communication with the vessel. The strainer comprises two portions: a first portion comprising a filter, and a second portion comprising no filter.

Thus, by tilting the vessel in one direction so that the pouring is made through the first portion, the mixed ingredients are strained while any ice is retained into the vessel. On the other hand, by tilting the vessel in another direction so that the pouring is made through the second portion, the mixed ingredients and the ice are poured into a glassware.

According to embodiments of the present invention, the vessel is securely connected to a robotic arm controlled by a robotic arm controller, which along with an ingredient frame forms the cocktail making assembly. By operating such an assembly, a user can order a mixed drink that will be automatically prepared and poured into the glassware.

### BRIEF DESCRIPTION OF THE DRAWINGS

Embodiments of the invention will now be described, by way of example, with reference to the accompanying drawings, in which:

FIG. 1 illustrates schematically a robotic cocktail making assembly according to an embodiment of the present invention;

FIGS. 2(a) and (b) illustrate a cocktail shaker according to an embodiment of the present invention along with an exemplary mount for the shaker;

FIGS. 3(a) and 3(b) illustrate a strainer for a cocktail shaker according to respective embodiments of the present invention; and

FIG. 4 illustrates a mixed drink management system, according to an embodiment of the present invention.

### DESCRIPTION OF THE EMBODIMENTS

It should be noted that in the detailed description that follows, identical or similar components, either from a structural and/or functional point of view, can have the same reference numerals, regardless of whether they are shown in different embodiments of the present disclosure. It should also be noted that in order to clearly and concisely describe the present invention, the drawings may not necessarily be to scale, and certain features of the disclosure may be shown in somewhat schematic form.

With reference to the attached figures, the present disclosure is related to a cocktail making assembly capable of preparing, agitating, for example by shaking or stirring, and pouring a mixed liquid substance.

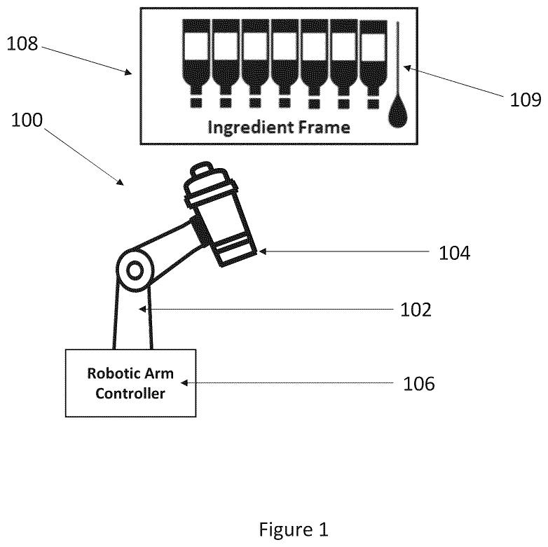

Referring now to FIG. 1, there is provided a system 100 according to an embodiment configured to mix a drink such as a cocktail.

The system 100 comprises a robotic arm 102 configured to mix a drink contained in a vessel 104 mounted on a free end of the arm. The vessel 104 is a cocktail shaker. The system further comprises an ingredient frame 108 configured to hold all the ingredients for making the cocktail drinks. This includes dispensers for spirits, drink mixers, fruit juices, syrups, soft drinks, garnishes, ice, water, coffee and glassware.

The spirits can be held in the frame in their original branded bottles, with legally stamped bar optic spirit measure dispensers as required by local regulations.

All the other liquids can be held in containers (bottles, tanks etc.) with mechanically or electronically controlled dispensing mechanisms like bar optic spirit measure, solenoids values, pumps, etc.

Ice and garnishes can be dispensed using mechanical or electronically controlled dispensing mechanisms. These can also be prepared automatically using other robotic devices; however, these other devices are not the specific concern of the present disclosure.

There is further provided a sink (not shown) used for disposing of ice after straining a cocktail and disposing of water after washing or rinsing out the vessel when the cocktail is poured.

When a drink order is to be prepared, the robotic arm 102 under the control of a controller 106 is actuated to move towards various locations of the ingredient frame 108 to obtain the appropriate ingredients for a recipe and to add these to the vessel 104.

The robotic arm 102 typically comprises a 6-axis industrial robot arm and can be an industrial robot or a collaborative robot (cobot). Different models from different manufacturers can be used, once the robotic arm can handle a payload, typically of the order of 1 kg.

The system 100 may also comprise a frame (not shown) surrounding the operational volume of the arm 102 to ensure isolation from human contact.

Once the required ingredients have been added to the vessel, the arm 102 can then mix the ingredients by shaking the vessel 104. Alternatively, some ingredients need to be stirred instead of shaken. For that case, the ingredient frame 108 further comprises a spoon or stirrer 109 in a position (shown schematically) that the robotic arm 102 can use to stir the contents of the vessel 104.

In a preferred embodiment, the vessel 104 is a cocktail shaker type container and the system comprises an electronically actuated clamp (not shown) that opens and closes a lid for the shaker when the shaker is mounted to the robotic arm 102. A strainer (not shown in FIG. 1) is located in the mouth of the shaker and allows the robot arm to pour a cocktail strained or not strained i.e., with or without ice, as will be discussed in more detail below.

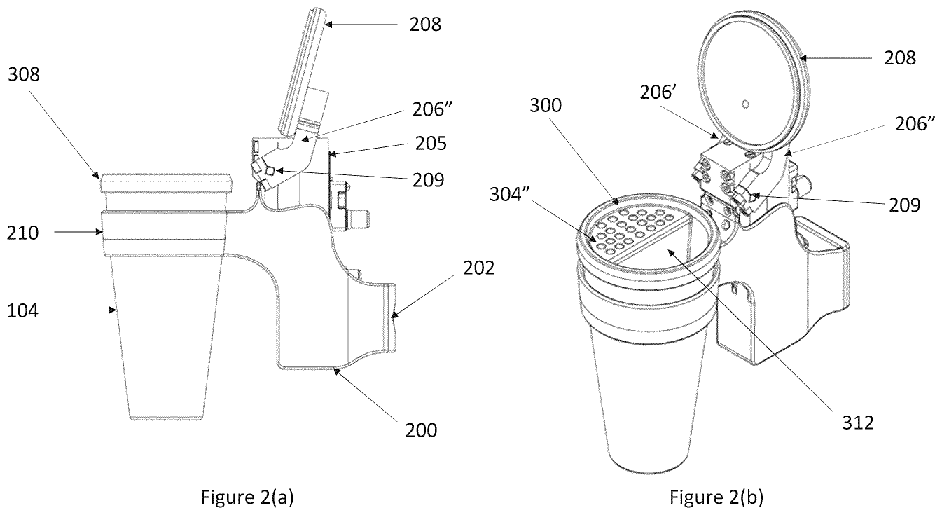

Referring now to FIG. 2(a), there is shown an exemplary mount 200 for connecting the robotic arm 102 to the vessel 104 according to an embodiment of the present invention.

The mount 200 is configured to be mechanically connected to the robotic arm 102 through a sleeve 202 which can be bolted to the end of the robotic arm 102. The mount comprises a collar 210 extending away from the sleeve 202 and which is configured to receive and securely hold the vessel 104. The collar 210 is typically circular, but other shapes can be used to adapt to a plurality of vessels of different respective shapes. In the embodiment, the collar comprises a thermoplastic polyurethane (TPU) lining, with the shaker 104 staying in place due to frictional forces created between the TPU lining and the vessel surface.

In an alternative embodiment, rather than a collar, the vessel 104 may be located on a base unit which in turn connects to the robotic arm 102. In that configuration, the vessel 104 can be kept in place with a magnet or electromagnet incorporated in the base unit. When the shaking operation is carried out by the robotic arm 102, the vessel 104 is held between the magnetic base and a closed lid 208, described in more detail below. In a still further embodiment, the vessel could twist or click fit into a base unit.

In any case, it will be appreciated that any suitable mechanism for allowing the vessel 104 to be mounted to the end of the robotic arm 102 can be employed. In this regard, it will be appreciated that it can be useful for the vessel to be readily placed and removed from any given mount without the need for tools to facilitate swapping in and out of shakers as required.

The mount 200 further comprises a block 205 located between the sleeve 202 and the collar 210. A pin 209 extends laterally through the block 205 with the pin being connected to an actuator (not shown) located within the block 205 and which when actuated by the controller 106 causes the pin to rotate back and forward. In an embodiment, the actuator comprises an electric motor, but it will be appreciated any suitable actuator could be employed. A lid 208 which is shaped to fit over and seal the mouth of the vessel 104 includes a pair of parallel spaced apart legs 206′, 206″ extending from the side of the lid, FIG. 2(b). A respective hole is formed in the distal end of each leg 206 and the pin 209 passes through each hole both to secure the lid 208 in place on the block 205 and to cause the lid 208 to move between the open and closed states when the controller 106 actuates the motor located inside the block 205.

Once all the ingredients have been dispensed into the vessel, where the ingredients are to be shaken, the lid 208 is configured to move from the open state to the closed state. As such, during the shaking operation, the vessel 104 is held between the collar 210 and the pressure applied by the lid 208.

Alternatively, where the ingredients are only to be stirred, the lid 208 remains in the open state, the arm 102 is moved so that the spoon/stirrer 109 is located within the vessel 104 and the arm 102 moves to cause the ingredients to be mixed by the spoon/stirrer 109. (As such, it will be appreciated that where the vessel 104 is mounted on a base unit, the connection between the vessel and base unit needs to be secure enough to allow the ingredients to be mixed without clamping the vessel 104 between the closed lid 208 and the base unit.)

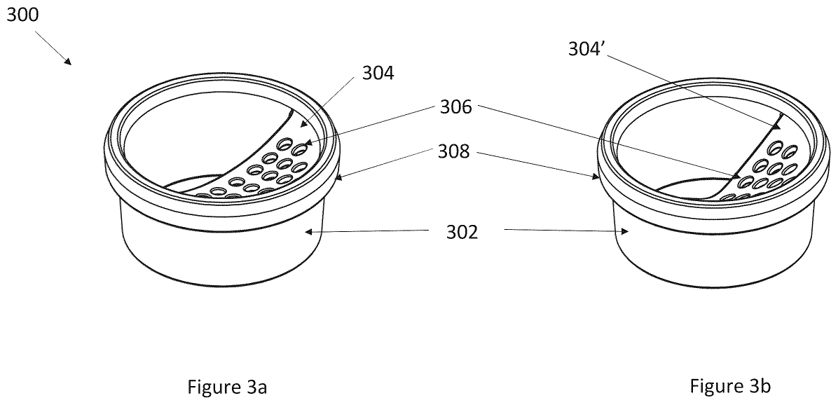

Referring now to FIG. 3(a), as mentioned above, the shaker 104 further comprises a strainer 300 configured to locate in the mouth of the shaker. In the embodiment, the mouth of the vessel is cylindrical and the strainer comprises a body 302 with generally cylindrical exterior surface. However, it will be appreciated that where the mouth of the vessel has a non-circular profile, the exterior surface of the strainer will be shaped accordingly.

The strainer 300 is typically of a unitary construction, and is typically formed of a rigid material, such as stainless steel, although other materials and constructions can be employed.

In a preferred embodiment, the strainer 300 is sized to make an interference fit with the shaker.

In some cases, one or more O-rings may be located on the interior surface of the mouth of the shaker to facilitate a seal between the strainer 300 and the shaker 104.

In an alternative embodiment, the strainer body 302 may be provided with external features which cooperate with corresponding features formed internally in the mouth of the vessel 104 to allow the strainer 300 to click or twist fit into the mouth of the vessel 104.

A peripheral flange 308 extends around one end of the strainer, so providing a stop and determining the extent to which the strainer 300 projects into the shaker with the flange 308 remaining proud of the mouth of the shaker 104 as shown in FIG. 2(a).

The cylindrical body 302 defines a generally hollow interior volume which provides a fluid communication channel with the interior of the shaker 104.

The channel is divided into two portions, with a first portion comprising a filter 304 in which a plurality of perforations 306 are defined extending laterally across the channel and an open second portion.

The filter can comprise any one of a number of profiles.

In FIG. 3(a), the filter 304 forms a concave depression at the end of the strainer with the peripheral lip and has an arcuate profile.

In a variant shown in FIG. 3(b), the filter 304′ is again concave and has a conical profile.

Each of these profiles tend to direct ingredients into the drinking vessel, especially through the open second portion, and avoid liquid being dispensed into the vessel 104 from splashing out of the vessel. Furthermore, these profiles tend to avoid any ice being stuck and obstructing the perforations 306 during the dispensing of mixed liquid from the vessel.

Nonetheless, other profiles can be used, and in FIG. 2(b), a strainer 300 with a filter 304″ having a linear profile is shown. In that case, the filter 304″ is shown extending orthogonally across the channel, whereas in still further variations the filter may incline into the body of the strainer 300, to again facilitate filling of ingredients into the vessel 104.

As shown in FIG. 2(b), the strainer 300 further comprises a lip 312 extending from an inner edge of the filter 304″ towards the vessel 104. The lip therefore provides a solid partition between the first portion of the interior of the strainer 300 and a second portion of the interior of the strainer which provides an open channel to and from the vessel 104.

Such a lip can also be employed in the strainers of FIG. 3.

In an exemplary embodiment, where the strainer is circular in profile across the channel, the first portion of the strainer comprising the filter 304 occupies approximately one half of the channel. However, it will be appreciated that other partitions of the strainer may be employed.

As will be appreciated, each of the strainers shown in FIGS. 2 and 3 are configured to allow passage of liquid and retention of solid material when the vessel is tilted in a first direction (towards the first portion) to dispense mixed ingredients, and to allow passage of liquid and solid material when the vessel is tilted in a second direction (towards the second portion) to dispense mixed ingredients.

As such, in the case of a cocktail making assembly 100, if the robotic arm 102 pours from one side of the shaker 104, the contents of the shaker can be poured with ice, ensuring that no filtering occurs; whereas by pouring from the other side of the shaker, the pouring filter 304, 304′, 304″ blocks the ice, and the arm can pour a strained cocktail drink i.e. without ice.

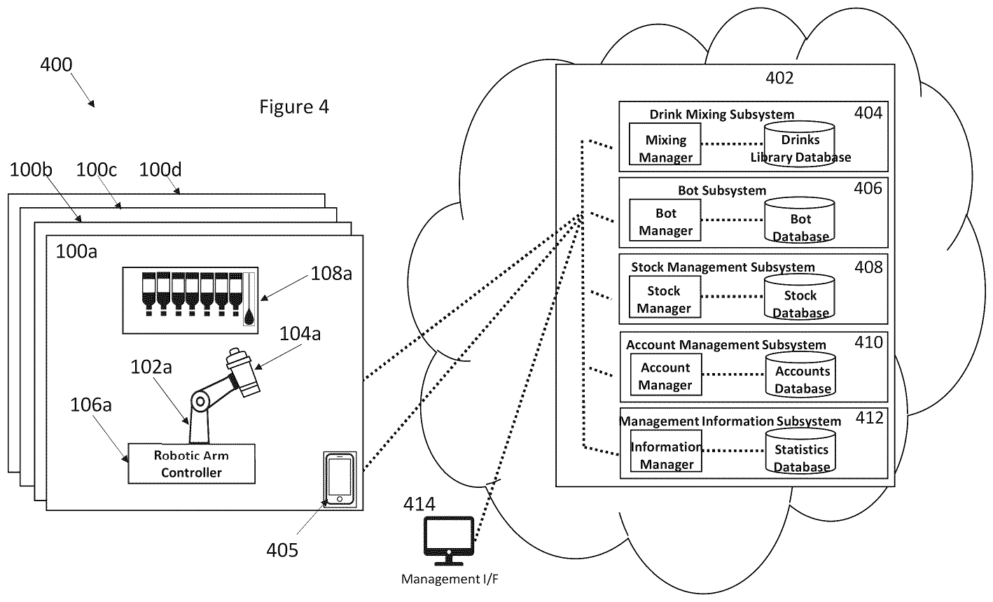

Referring now to FIG. 4, there is shown an autonomous mixed drinks making system 400 for controlling a plurality of cocktail making assemblies 100a . . . 100d, at least one of which comprising a mixing vessel 104 including a strainer 300 such as illustrated in FIGS. 2 and 3. Such a system manages the making of mixed drinks for customers. The cocktail making assembly 100a-d may be in one or a multitude of venues, all networked together, with the system 400 automating the selection of ingredients and mixing of cocktails, once a user has picked the cocktail that they want mixed.

The system 400 has two main parts, the cocktail making assembly 100a-d and a backend management system 402. The cocktail making assemblies 100a-d are located in one or more venues to mix cocktails and may operate autonomously or may be operated by the bartenders in the venues.

All the cocktail making assemblies 100a-d are linked, over a suitable network such as the Internet, to the backend management system 402. It will be appreciated that while four cocktail making assemblies are shown in FIG. 4, there can be any number of such assemblies.

As mentioned, each cocktail making assembly 100a-d is configured to mix and serve the cocktails. In each venue there can be one or more cocktail making assembly. Having more than one assembly, they can be differentiated for example by using the naming convention of colours of the rainbow. Alternatively, other naming conventions may be used.

In the example, each robotic arm controller 106 is connected to the backend management system 402 over the Internet. The backend management system 402 sends the cocktail making instructions to the robotic arm controller to move the arm and mix the cocktail in the desired way.

A user typically uses an application running on a tablet, phone device or dedicated terminal 405 at the venue to select and send requests for cocktails to be mixed to the backend management system 402. The application runs on the tablet/phone device 405 and can manage one or more cocktail making assembly 100a-d. Once the application is registered and authenticated, it connects to the backend management system 402 and displays a list of cocktails that can be mixed based on the ingredients in the ingredient frame 108 at that time. The user selects the cocktail that they want mixed, and the application sends a request to the backend management system 402 to make that cocktail.

The system 402 then sends back instructions to the robotic arm controller 106 to move the vessel 104 to get the ingredients and mix and pour the cocktail.

Another application running on device 405 may also be used by a bartender or any person with authorisation to restock the ingredients frame 108 i.e., allocate ingredients to positions in the ingredient frame 108. These positions are typically called “bottle positions”. A bottle position is the position the robotic arm 102 must place the vessel 104 to dispense the ingredients into the vessel 104.

As indicated, the robotic arm controller 106 executes instructions sent by the backend management system 402 to operate the arm 102 by translating the instructions into the robotic arm's proprietary instruction set.

The controller 106 can also interface with other devices such as sensors, external motion axes or vision systems to improve its position accuracy or to trigger events etc.

The backend management system 402 has several subsystems to manage and control its functions. Because the system 402 is a cloud-based system, it is easy to scale and can manage a plurality cocktail making assemblies 100a-d in a plurality of venues.

The drink mixing subsystem 404 manages the mixing of the cocktail drinks and comprises a database of recipes for cocktails stored in a drinks library database. A mixing manager receives the requests to mix a cocktail using one of the cocktails making assemblies 100a-d from the application. The mixing manager retrieves the cocktail recipe from the drinks library database. A recipe typically includes the ingredients required, ways to mix (shake, stir, etc.), or the type of glassware to pour into (highball, Martini glass, Collins glass, coupe glass, etc).

The mixing manager then sends the recipe to a bot manager in a bot subsystem 406 to get a Drink Execution Program for the robotic arm 102. This program is a list of instructions to operate the robotic arm 102 to mix the cocktail and the Mixing Manager sends that program to the robotic arm controller of the appropriate cocktail making assembly.

When the robotic arm controller 106 sends a confirmation that the cocktail has been poured into the glassware, the Mixing Manager sends the information to the Stock Manager in the Stock Management Subsystem 408 to adjust the stock levels for that cocktail making assembly 100. Based on the revised stock levels in the assembly, the Stock Manager informs the Mixing Manager of the updated availability of the ingredients of the frame 108. The Mixing Manager can then determine what cocktails it can mix using the Drinks Library Database and update the application to display this list.

In a further example, if there are no or insufficient levels of ingredients in the cocktail making assembly ingredients frame 108 to make any cocktail, a “Restock Ingredients Frame” message will be displayed in a management interface application running on a management computer 414.

The Mixing Manager will then inform an Account Manager in an Account Management Subsystem to update the sales figures. Finally, the Mixing Manager informs the Information Manager in the Management Information Subsystem 412 to update all the relevant statistical counters.

All the cocktail making assemblies 100a-d are managed by the Bot Subsystem 406 in the backend management system 402. The Bot Manager allows an authorised user using the application to register a new cocktail making assembly in venues, to register bartenders for using any assembly and register the position of ingredients in the ingredient frame 108.

When the Bot Manager receives a cocktail recipe from the Mixing Manager, the Bot Manager generates a Drink Execution Program for a specific cocktail making assembly to operate the robotic arm 102 to mix the cocktail, and the Bot Manager sends the Drink Execution Program to the robotic arm controller 106. The Drink Execution Program can be implemented as a set of instructions in a language called JLingo. Each assembly may have ingredients in different positions in the ingredient frame 108. The Bot Manager converts the ingredients required from the cocktail recipe into dispensing positions (Bottle Positions) to place the vessel adequately to dispense the ingredients for that specific cocktail making assembly.

Managing the stock of ingredients across all the cocktail making assemblies 100a-d is carried out by the Stock Management Subsystem 408 which comprises a Stock Database and a Stock Manager module.

The Stock Manager allows authorised users to use the application to “stock up” and set the stock levels of the ingredients in the cocktail making assembly 100a-d. In an exemplary embodiment, by using Machine Learning and Artificial Intelligence, the Stock Manager can indicate the best positions in the ingredients frame 108 to place ingredients to minimise the time to make cocktails.

The Mixing Manager in the Drink Mixing Subsystem 404 updates the Stock Manager about the ingredients used after a cocktail is poured by a cocktail making assembly. The Stock Manager can then adjust the levels of stock and confirm the levels by monitoring sensors on the ingredients frame 108. The Stock Manager then updates the Mixing Manager with the new status of stock, to display what cocktail drinks can be mixed with this cocktail making assembly.

The Stock Manager, using machine learning and AI, can issue stock level alerts and reorder lists to the appropriate people. The Account Management Subsystem 410 enables a user to manage their account. The user accesses the Account Manager online or using the application. After authentication, the user may then manage venues, setup venues and assign cocktail making assemblies to the venues. For each venue, a user can assign bartenders to cocktail making assemblies to operate the assemblies.

The Management Information Subsystem 412 generates various reports on the performance of the system 400. This subsystem has a database of counters that the Information Manager continually updates. From this database various reports may be generated to show how the system is operating, trends that are happening, etc.

When using a cocktail making assembly 100a-d in a given venue, the cocktail making assembly must first be activated by a user. To activate a cocktail making assembly in a venue, the user first opens an application on a device 405. The device may be a tablet, a phone, a computer, etc. Where the assembly operates completely autonomously, the device may be the user's personal device. Alternatively, the device 405 may be a user interface device provided at the assembly 100. Where the device 405 is a personal device, the user can also authenticate on a website. Where the device is provided as part of the assembly, 100, the device can be on the same secure network as the cocktail making assembly.

In any case, the user logs into a user account. The account will typically have been pre-configured with one or more venues one or more cocktail making assembly associated with each venue.

The user selects the desired venue. After selecting the venue, a list of preconfigured cocktails making assemblies will be displayed. These assemblies have been allocated to the selected venue, and the user may then select the assembly they want to activate.

Once a cocktail making assembly has been activated, where the assembly is not completely autonomous, an authorised bartender can then use the assembly. A list of preconfigured bartenders that can operate the activated assembly and associated with the selected venue is displayed.

When one of the authorised bartenders presses their name, they are authorized to use the cocktail making assembly to prepare the ordered drink through the Management Interface 414.

The active bartenders for the activated assembly are typically pre-registered and, depending on configuration, may be asked to authenticate themselves by using a pre-configured authentication method e.g., PIN, biometric, etc.

If there are no or insufficient levels of ingredients in the assembly's ingredient frame 108 to make cocktails, a “Restock Ingredients Frame” message will be displayed. In that situation, the ingredients frame 108 must be restocked before going any further.

If there are sufficient ingredients available to make cocktails in the assembly's ingredients frame, a list of these cocktails will be displayed. The cocktails that are listed at a given time depend on the stock content of the ingredient frame at that time. The Stock Management Subsystem 408 keeps track of the stock content of the ingredient frame for each cocktail making assembly 100a-d. The cocktails are typically listed in order of the most popular ordered up to that time on that assembly. A search function is also available for the bartender to start typing in the name of a cocktail. A list of cocktails is then displayed, matching the cocktail name as it is typed. The list of cocktails preferably comprises only the drinks that the cocktail making assembly can make from the ingredients available in the ingredient frame 108 at that time.

In a further embodiment, additional information about the cocktail drink may be also displayed such as price, ingredients, allergy information, etc.

A user of an activated cocktail making assembly 100a-d and who has been authenticated can order the assembly to prepare a cocktail drink from the displayed list on the application display.

Once the user selects the cocktail that they want mixed by the assembly from the list of cocktails available, the application sends the cocktail request to the backend Drink Mixing Subsystem 404.

The Drink Mixing Subsystem 404 sends a Drink Execution Program to the robotic arm controller 106. Specifically, the Drink Mixing Subsystem generates a program of instructions for the robotic arm controller to execute to make the cocktail.

Based on the cocktail requested, the Drink Mixing Subsystem 404 looks up the recipe to make the cocktail in the Drinks Library Database. This recipe includes the ingredients required, mixing methods (shake, stir etc.), type of glass to pour into, etc.

The Drink Mixing Subsystem 404 then translates the cocktail's recipe into a set of instructions for the robotic arm 102 to make the cocktail.

By using the list of ingredients required from the recipe, the Drink Mixing Subsystem 404 generates instructions to move the robotic arm 102 to the appropriate bottle position to get the ingredients on the assembly's ingredient frame 108.

By using the mixing methods as specified in the recipe, the Drink Mixing Subsystem 404 adds instructions to the Drink Execution Program on how to mix the cocktail.

The Drink Mixing Subsystem also adds instructions for selecting a glass to pour the cocktail into.

Subsequently, the Drink Mixing Subsystem translates the way to pour the cocktail, strained or not strained etc., as specified in the recipe to a set of instructions for the robotic arm 102.

All these instructions make up the Drink Execution Program and the Drink Mixing Subsystem 404 sends the program to the appropriate robotic arm controller.

The Drink Mixing Subsystem 404 sends cocktail information to the application.

The application displays information about the cocktail, like the list of ingredients, as well as instructions for the bartender like what the glassware that should be used, or any special instructions about serving, for example.

Alternatively, for a cocktail making assembly that do not automatically select the glassware, the bartender can manually select the glassware and place the glass in the pouring position.

The robotic arm controller 106 executes the Drink Execution Program:

The robotic arm controller 106 executes the program to operate the robotic arm 102 which has the vessel 104 attached.

The robotic arm controller 106 can operate the shaker lid 208 to move between an open state and a closed state and to move the shaker 104 to various positions. For ingredients that need to be dispensed with optic spirit measure dispensers comprised in the ingredients frame 108, the robotic arm controller 106 moves the shaker 104 under the appropriate bottle, pushes the shaker up against the optic trigger mechanism and holds the shaker in position until the liquid is fully dispensed.

Other liquids, ice and garnishes can be dispensed by the robotic arm controller 106 using mechanical or electronic mechanisms. For mechanical dispensing, the robotic arm controller 106 moves the shaker 104 to push a lever for a fixed time to dispense the required quantity of ingredient. For electronic dispensing, the robotic arm controller 106 moves the shaker 104 under an appropriate dispenser (for example a spout, a tap or a tube) and then the robotic arm controller 106 triggers the opening of a solenoid or pump. The length of time the solenoid or pump is operating determines the amount of ingredient dispensed.

Instructions on how to mix the cocktail, if mixing is required, will be included in the Drink Execution Program. For a mixed drink requiring shaking, the robotic arm controller 106 moves the shaker lid 208 into a closed state and moves the shaker 104 in a up and down or any other suitable motion. Different levels of shaking (light, medium, vigorously etc.) may be specified by the Drink Execution Program.

Alternatively, for a mixed drink requiring stirring, the robotic arm controller 106 moves the shaker to put the spoon/stirrer 109 comprised in the ingredients frame 108 inside the shaker 104 at a sufficient depth to stir the ingredients. In this case, the second portion of the strainer should be sufficiently wide to allow the spoon/stirrer 109 to pass into the vessel and engage with the ingredients to be mixed within the vessel. The robotic arm controller 106 then applies a horizontal circular or other suitable motion to the vessel 104 to stir the ingredients of the mixed drink. Similarly, different levels of stirring (light, medium, vigorously) can be carried out if specified by the Drink Execution Program.

Finally, once all the ingredients are added to the shaker and mixed together, the robotic arm controller 106 moves the shaker 104 to pour the contents into the glass.

The robotic arm controller 106 is further configured to pour the ice and mixed ingredients contained in the vessel 104 into a glassware, or to strain the mixed ingredients through the ice and into the glassware. As mentioned, the way to pour a cocktail is specified in the set of instructions sent by the Drink Mixing Subsystem 404 to the robotic arm controller 106.

In an exemplary embodiment, the glassware is positioned at a common position and the robotic arm controller 106 moves the vessel 104 to a side of the glassware. If the drink must be poured with the ice, the robotic arm controller 106 moves the vessel to a first side of the glassware and tilts the vessel 104 so that the ingredients and ice are poured through the second portion of the strainer 300. On the contrary, for a drink that must be poured without ice, the robotic arm controller 106 moves the vessel to a second side of the glassware and tilts the vessel 104 so that the ingredients are poured through the first portion of the strainer 300. The ingredients will be poured through the apertures 306 of the filter 304, 304′, 304″, while the ice will be retained within the vessel 104.

Alternatively, in a further embodiment, the cocktail making assembly 100 may be provided with several glassware slots, each slot being assigned to a specific pouring instruction. For example, for a drink that must be poured without ice, the robotic arm controller 106 moves the vessel towards a first glassware located at a specified first position and tilts the vessel 104 so that the ingredients are poured through the first portion of the strainer 300. Alternatively, for a drink that must be poured without ice, the robotic arm controller 106 moves the vessel towards a second glassware located at a specified second position and tilts the vessel 104 so that the ingredients are poured through the second portion of the strainer 300.

When the mixed drink has been poured into the glassware, the robotic arm controller 106 then informs the Bot Manager that the cocktail has been served. The Bot Manager passes on the confirmation to the Drink Mixing Subsystem 404.

The Drink Mixing Subsystem 404 triggers the adjustment by the Stock Manager of the stock levels for all the ingredients used and triggers the updating of the relevant statistical counters by the Information Manager. Without limitation, the counters comprise the number of cocktails served, the time taken to serve the cocktails, the cocktails count for each bartender, etc.

1. A cocktail making assembly comprising:
a cocktail shaker comprising a tumbler configured to receive a strainer, the strainer comprising:
a strainer body defining an exterior surface sized and shaped to fit a mouth of the tumbler and an interior surface defining a channel for fluid communication with the tumbler, the channel comprising:
a first portion comprising a filter, the filter being configured to allow passage of liquid and retention of solid material when the tumbler is tilted in a first direction; and
a second portion being configured to allow passage of liquid and solid material when the tumbler is tilted in a second direction;
a robotic arm securely connected to the cocktail shaker and configured to move the cocktail shaker; and
a controller configured to control the movement of said robotic arm in accordance with a respective set of program instructions for a given cocktail, at least one set of program instructions causing said controller to tilt said tumbler in said first direction to dispense a mixed cocktail into glassware and to retain ice within said tumbler; and at least one other set of program instructions causing said controller to tilt said tumbler in said second direction to dispense another mixed cocktail and ice from said tumbler into glassware.

2. The cocktail making assembly of claim 1, wherein the strainer is of a unitary construction.

3. The cocktail making assembly of claim 1, wherein the strainer is formed of a rigid material.

4. The cocktail making assembly of claim 1, wherein a surface of the filter has a concave profile to provide an outwardly depressed surface for the first portion of the strainer when fitted to the tumbler.

5. The cocktail making assembly of claim 4, wherein the surface of the filter has a conical profile.

6. The cocktail making assembly of claim 4, wherein the surface of the filter has an arcuate profile.

7. The cocktail making assembly of claim 4, wherein a surface of the filter is planar.

8. The cocktail making assembly of claim 7, wherein the surface of the filter extends parallel to the mouth of the tumbler when the strainer is fitted to the tumbler.

9. The cocktail making assembly of claim 7, wherein the surface of the filter inclines towards the tumbler when the strainer is fitted to the tumbler.

10. The cocktail making assembly of claim 1, wherein the strainer is symmetric in profile across said channel.

11. The cocktail making assembly of claim 10, wherein the strainer is circular in profile.

12. The cocktail making assembly of claim 10, wherein the first portion occupies approximately one half of said channel profile.

13. The cocktail making assembly of claim 1, comprising a lip extending from an inner edge of the filter towards the tumbler in order to retain solid material with an interior volume defined by said interior surface of said strainer body, said filter and said lip.

14. The cocktail making assembly of claim 1, further comprising a lid sized and shaped to fit a mouth of the cocktail shaker, wherein the clamp is configured to move the lid between an open state and a closed state in accordance with a set of program instructions for a given cocktail.

15. The cocktail making assembly of claim 14 wherein at least one set of program instructions for a cocktail causes said lid to remain in an open state, said robotic arm to move so that a stirrer passes through said second portion of said channel into contact with ingredients in said tumbler and said robotic arm to move to cause said stirrer to mix said ingredients.

16. A system comprising:
at least one cocktail making assembly comprising:
a cocktail shaker comprising a tumbler configured to receive a strainer, the strainer comprising:
a strainer body defining an exterior surface sized and shaped to fit a mouth of the tumbler and an interior surface defining a channel for fluid communication with the tumbler, the channel comprising:
a first portion comprising a filter, the filter being configured to allow passage of liquid and retention of solid material when the tumbler is tilted in a first direction; and
a second portion being configured to allow passage of liquid and solid material when the tumbler is tilted in a second direction;
a robotic arm securely connected to the cocktail shaker and configured to move the cocktail shaker; and
at least one controller configured to control the movement of said robotic arm for the at least one cocktail making assembly in accordance with a respective set of program instructions for a given cocktail, at least one set of program instructions causing said controller to tilt said tumbler in said first direction to dispense a mixed cocktail into glassware and to retain ice within said tumbler;
and at least one other set of program instructions causing said controller to tilt said tumbler in said second direction to dispense another mixed cocktail and ice from said tumbler into glassware, wherein the at least one controller is configured to communicate with a central management system across a network in order to control the at least one cocktail making assembly.
